(19) United States
(12) Patent Application Publication
(10) Pub. No.: US 2020/0080354 A1
(43) Pub. Date: Mar. 12, 2020

(54) PORTAL COVER SECURITY

(71) Applicant: Robert E. Flatman, Newington, GA (US)

(72) Inventor: Robert E. Flatman, Newington, GA (US)

(21) Appl. No.: 16/562,853

(22) Filed: Sep. 6, 2019

Related U.S. Application Data
(60) Provisional application No. 62/728,400, filed on Sep. 7, 2018.

(51) Int. Cl. E05C 19/00

(52) U.S. Cl. CPC E05C 19/003

(57) ABSTRACT

Technology to secure portal covers includes at least two structure fixtures. Each structure fixture is independently securable to a structure at different sides of an opening in the structure adapted for a portal cove. Technology includes a spanning element adapted to rigidly and releasably engage each structure fixture across the opening. At least one portal cover engagement subsystem is adapted to releasably secure the spanning element and to the portal cover, thereby impeding opening of the portal cover when the spanning element is engaged with the structure fixtures across the opening.

### CROSS REFERENCE TO RELATED APPLICATION

This application claims the benefit of U.S. Provisional Patent Application No. 62/728,400 filed Sep. 7, 2018, entitled “Portal Cover Security.” The complete disclosure of the above-identified priority application is hereby fully incorporated herein by reference.

### TECHNICAL FIELD

The disclosed technology relates to portal cover security. Example embodiments relate to barricades for doors.

### BRIEF DESCRIPTION OF THE DRAWINGS

FIG. 1 through FIG. 5 depict structure fixtures, a spanning element, and a compression type portal cover engagement subsystem of the present technology arranged around a portal cover (a door) installed in an opening (a doorway) of a structure (a building wall), in accordance with examples of the technology disclosed herein.

FIG. 6 depicts a portion of a spanning element hanging on a “T” shaped structural fixture in an unengaged configuration for storage, in accordance with examples of the technology disclosed herein.

FIG. 7 depicts a “T” shaped structure fixture attached to a wall outside a doorway, in accordance with examples of the technology disclosed herein.

FIG. 8 depicts a “T” shaped structure fixture attached to a wall outside a doorway and a second portion of a threaded portal cover engagement subsystem attached to the door, in accordance with examples of the technology disclosed herein.

FIG. 9 depicts a portion of a structure fixture attached to a wall outside a doorway, a portion of a spanning element, and a first portion of a rigid bar portal cover engagement subsystem engaging a second portion of the rigid bar portal cover engagement subsystem that is attached to the door, in accordance with examples of the technology disclosed herein.

FIGS. 10-12 depict a structure fixture attached to a wall outside a doorway, a first portion of a portal cover engagement subsystem attached to a spanning element, and rigid bar portal cover engagement subsystem, in accordance with examples of the technology disclosed herein.

FIG. 13 is a block flow diagram depicting methods to secure portal covers, in accordance with examples of the technology disclosed herein.

### DETAILED DESCRIPTION OF EXAMPLE EMBODIMENTS

Personal security for you or your family is of the upmost importance. Without this peace of mind, the feeling of safety and security may prevent you from fully relaxing. The technology disclosed herein can secure a portal cover (such as a door or window) in an opening (such as a doorway) that will enable you to enjoy your privacy with the knowledge that you or your family are protected.

The technology disclosed herein may be used in all types of structures from college dorms, to family homes, to commercial buildings. It can be operated by youngsters to senior citizens. This technology also can be tailored for any size door, any size walls (e.g., 4-inch or 6-inch walls), right or left-handed hinges, inswing or outswing, and for a multitude of door types. The technology disclosed herein also can be applied to other portal covers, such as windows (sash, casement, awning), garage doors, shutters, and dutch doors. The technology disclosed herein offers a degree of safety from invasions both as a deterrent or as a fall back safety to secure a room.

There are several types of barricades that attempt to prevent home invasions. The degree of success varies with the most popular models now on sale: floor units that secure the bottom of the door; floor to knob units, and barricade units. There are several weaknesses to these current applications: placement of locking devices only fortifies a portion of the door; a singular reinforced point leaves the door vulnerable in other areas; some devices allow movement of the door; there are limited types of doors that these devices can be used on; and the known devices can time consuming and cumbersome to deploy. The technology disclosed herein addresses one or more of the shortcomings of existing approaches.

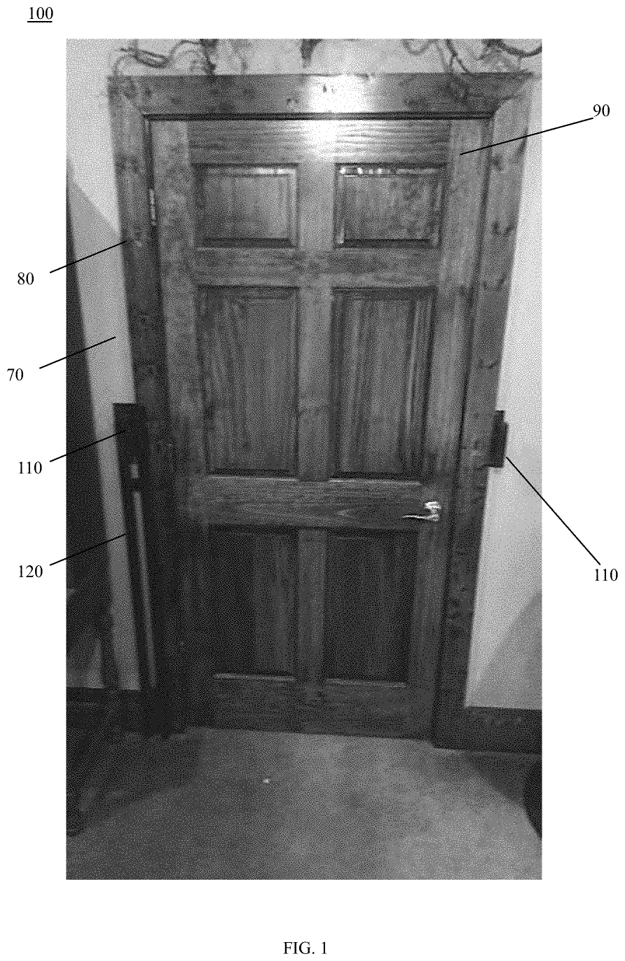

Referring to FIGS. 1-5, a system 100 to secure portal covers is shown in context with an inward-opening door 90 in an opening (defined by doorframe 80) in a wall 70 of a structure, in accordance with examples of the technology disclosed herein. The system 100 includes two structure fixtures 110, a spanning element 120, and a compression type portal cover engagement subsystem 130 (shown in some figures). In FIG. 1, two “T” shaped structure fixtures 110 are shown attached to the wall 70 of the structure outside the opening defined by doorframe 80. The spanning element 120 and compression type portal cover engagement system 130 are shown in a stored position hanging from the left structure fixture 110. While structure fixtures 110 are shown attached to wall 70, structure fixtures can be attached to frame 80.

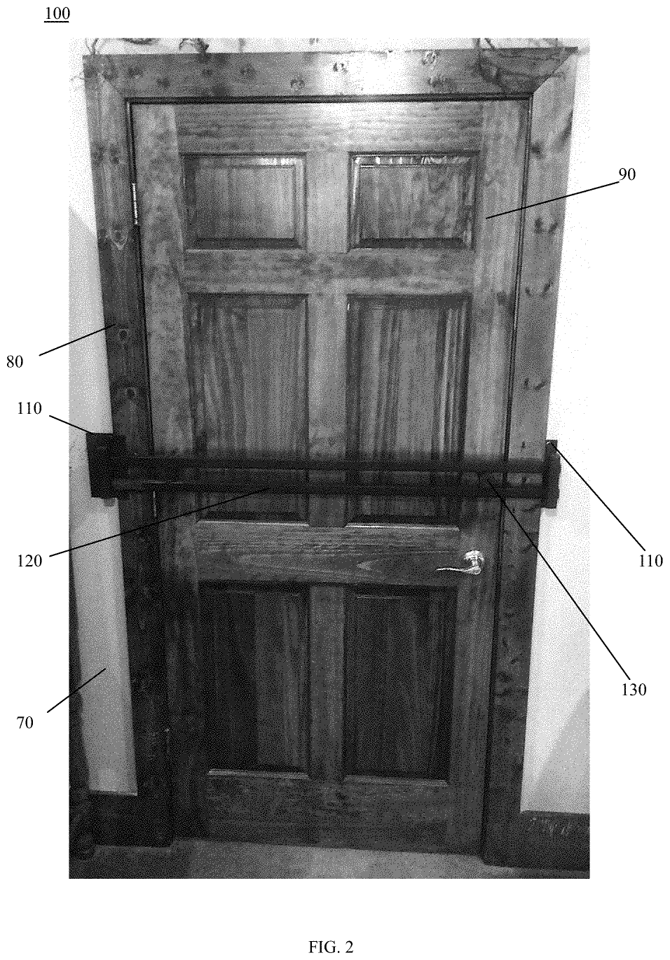

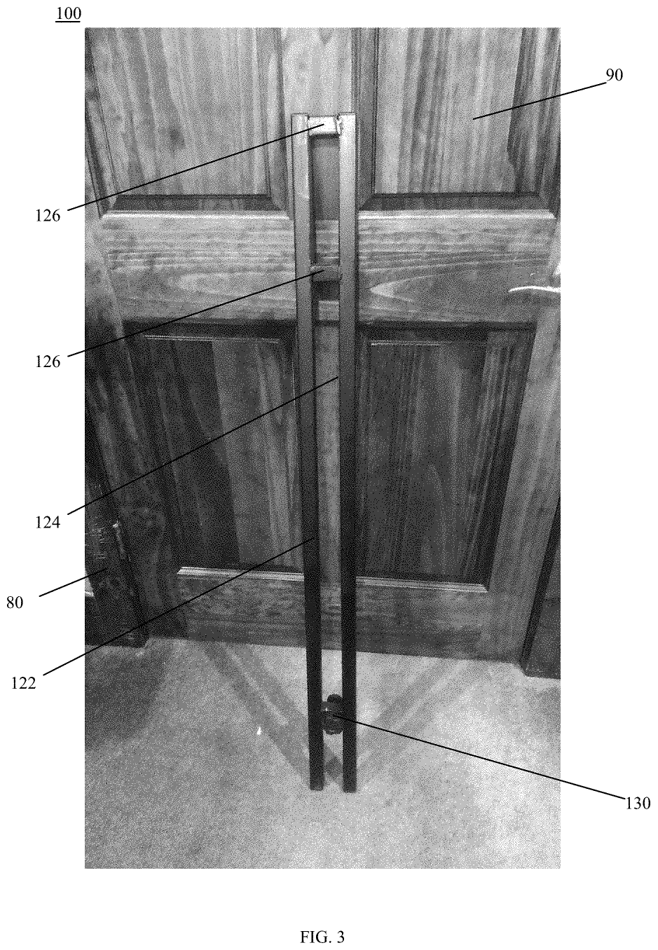

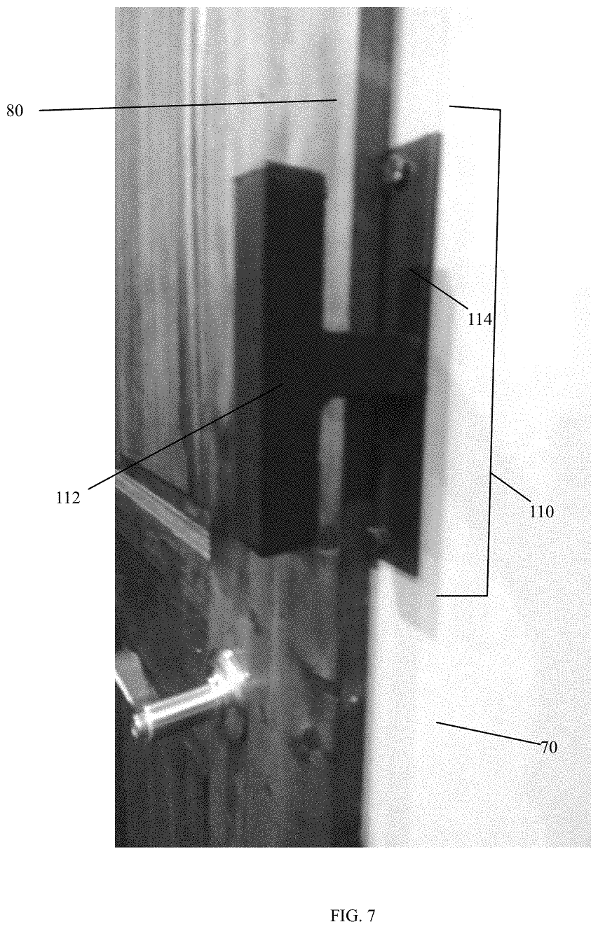

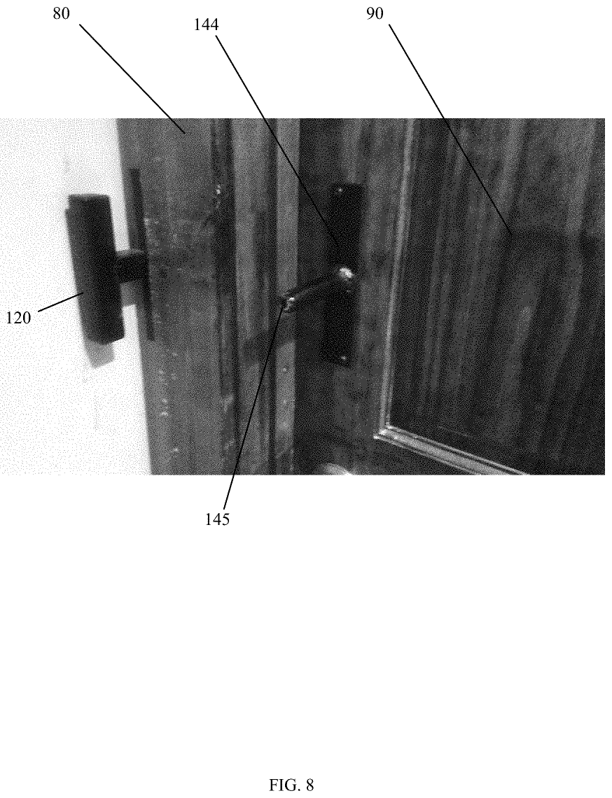

In FIG. 2, the spanning element 120 is engaged with the left and right structure fixtures 110 across the opening formed by the doorframe 80. In FIG. 3, a pair of rectangular metal tubes 122 and 124 (1″ square in the example) of the spanning element 120 are shown. Each tube 122 and 124 is characterized by a long dimension sufficient to span the opening defined by doorframe 80 (47 ½″ in the example for a 3′ wide door). Each tube 122 and 124 and engages a structure fixture 110 in the space between the “T” portion 112 of the structure fixture 110 and a plate 114 of the structure fixture 110 (not clearly shown in FIG. 2, but shown in FIG. 7 and FIG. 8), and by a depth less than that space. In some embodiments, tubes 122 an 124, along with spacers 126 can be shaped other then rectangular, for example, as circular pipes.

The tubes 122 and 124 are separated to be substantially parallel by spacers 126 and by compression type portal cover engagement subsystem 130. Both the interior spacer 126 and the compression type portal cover engagement subsystem 130 are about 8″ from the end of the spanning element 120 in the example. The opening formed by the spacers 126 and the tubes 122 and 124 is sufficient to admit the “T” shaped structure fixture.

In use, the spanning element 120 is hung on the left structure fixture 110 via the opening formed between the spacers 126. The spanning element 120 is then rotated (counterclockwise in the case of FIGS. 1-5) and slid to the left before the open end of the spanning element 120 (the end proximal to compression type portal cover engagement subsystem 130) is slid to the right over the right structure fixture 110.

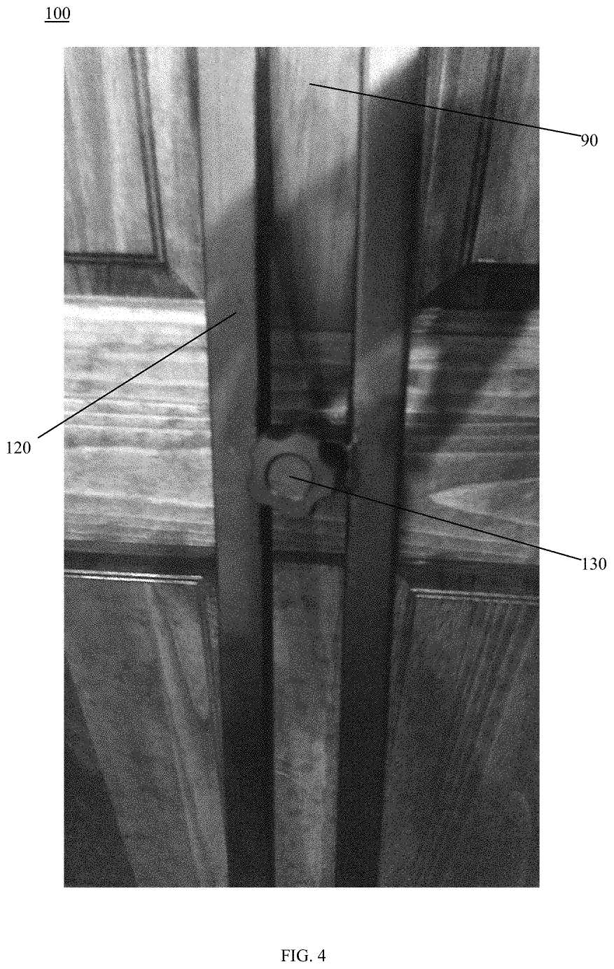

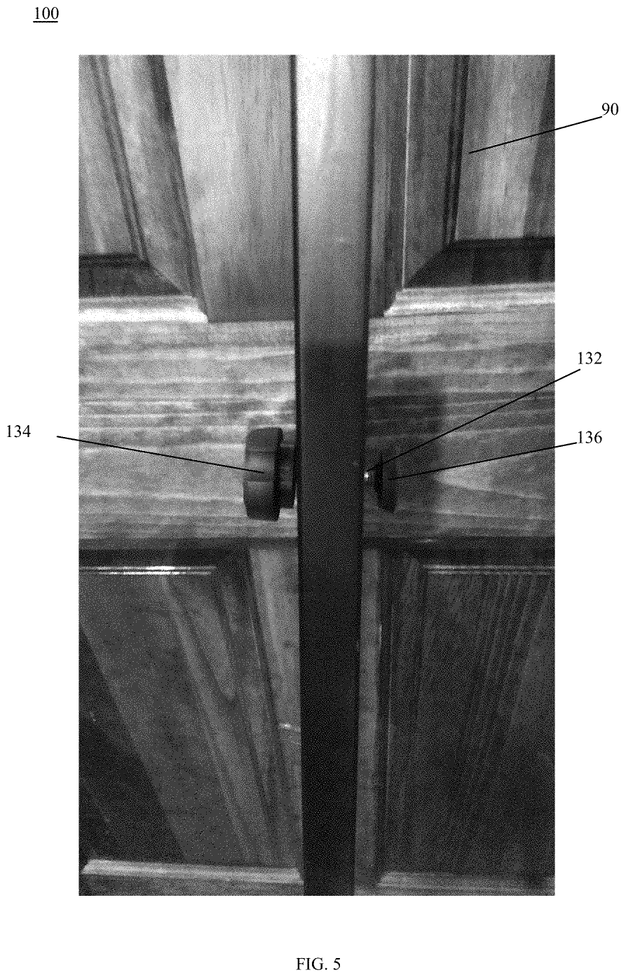

FIG. 4 and FIG. 5 show the compression type portal cover engagement subsystem 130 in more detail. FIG. 5 shows a threaded shaft 132 rotatably captive in a hole formed through a spacer 126 (not explicitly shown), along with a nob 134 used to turn the threaded shaft 132, thus impelling a heel 136 (in this example, a rubber heel) toward the door 90 from the spanning element 120. This applies a force to the inward-opening door 90 deterring the door 90 from opening. In some embodiments, a compression type portal cover engagement subsystem 130 is used at multiple locations along the spanning element 120.

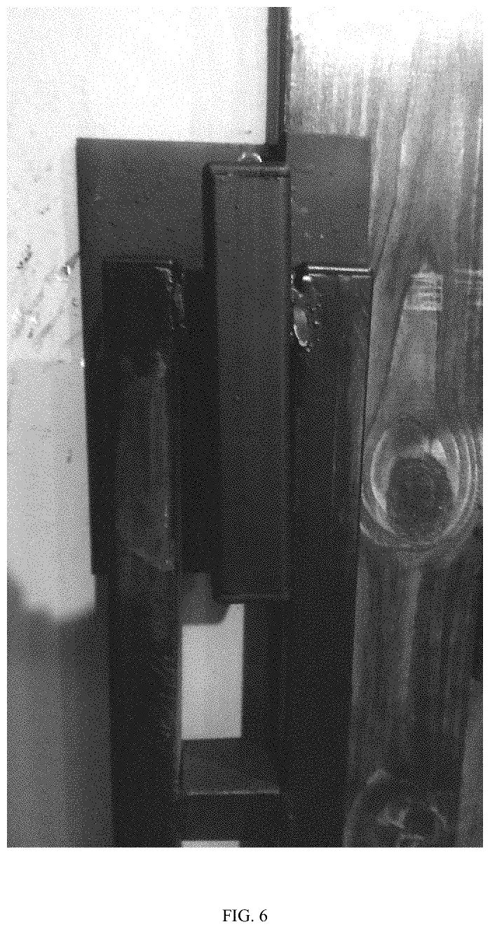

FIG. 6 depicts a portion of a spanning element 120 hanging on a structure fixture 110 in an unengaged configuration for storage, in accordance with examples of the technology disclosed herein.

FIG. 7 depicts a structure fixture 110 attached to a wall 70 outside a doorway, in accordance with examples of the technology disclosed herein. In the example of FIG. 7, the “T” portion 112 of the structure fixture 110 is made from the same material as the spanning elements 120, and is 5″ tall. The structure fixture is supported by a ⅛″×7″×1 ¼″ metal plate 114, and secured by two ⅜″×3 ½″ lag screws. Each tube 122 and 124 of the spanning element 120 and engages a structure fixture 110 in the space between the “T” portion 112 of the structure fixture 110 and a plate 114 of the structure fixture 110, and by a depth less than that space. In FIG. 7 it can be seen that door frame 80 reduces the amount of space available between the plate 114 and the “T” portion 112.

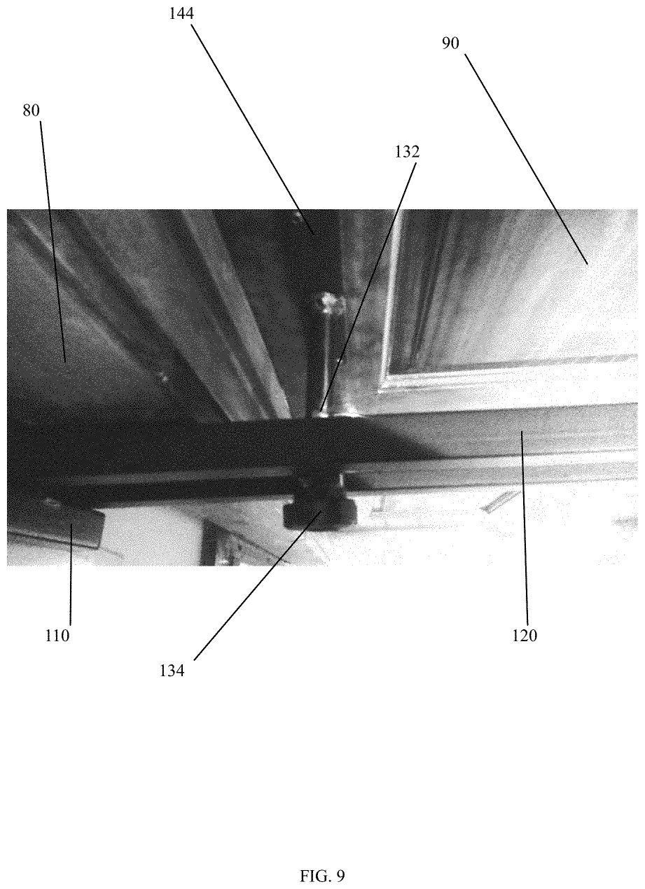

FIG. 8 and FIG. 9 depict a structure fixture 110 attached to a wall 70 outside a doorway, a portion of a spanning element 120, and a threaded portal cover engagement subsystem 140. The threaded portal cover engagement subsystem 140 includes a first portion 142 attached to the spanning element 120 (such as through a spacer 126), and a second portion 144 attached to the portal cover 90. The first portion 142 includes a threaded shaft 132 and knob 134 as in the compression type portal cover engagement subsystem 130. Instead of a heel 136 as used in the compression type portal cover engagement subsystem 130, the threaded portal cover engagement subsystem 140 uses a second portion 144 including a threaded receiver 145 that accepts the threaded shaft 132.

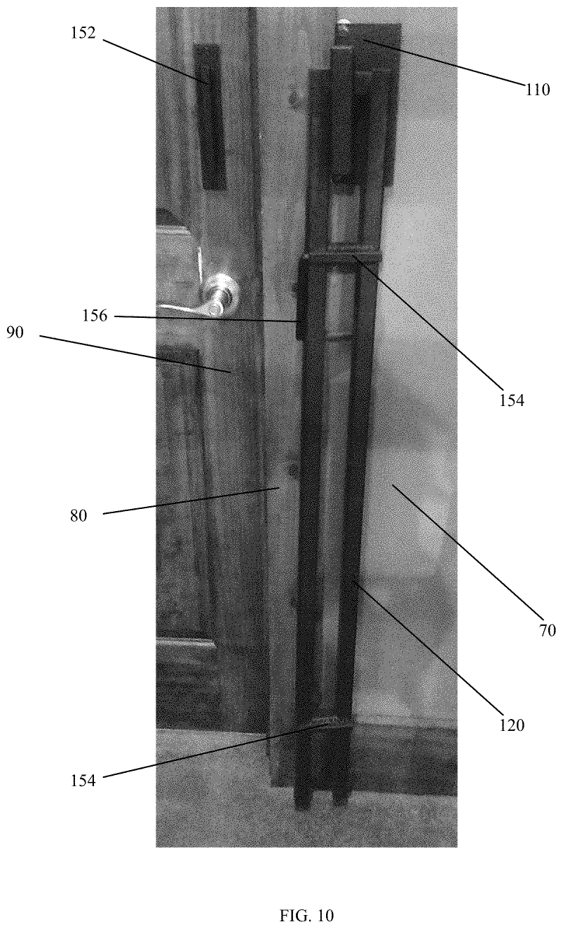

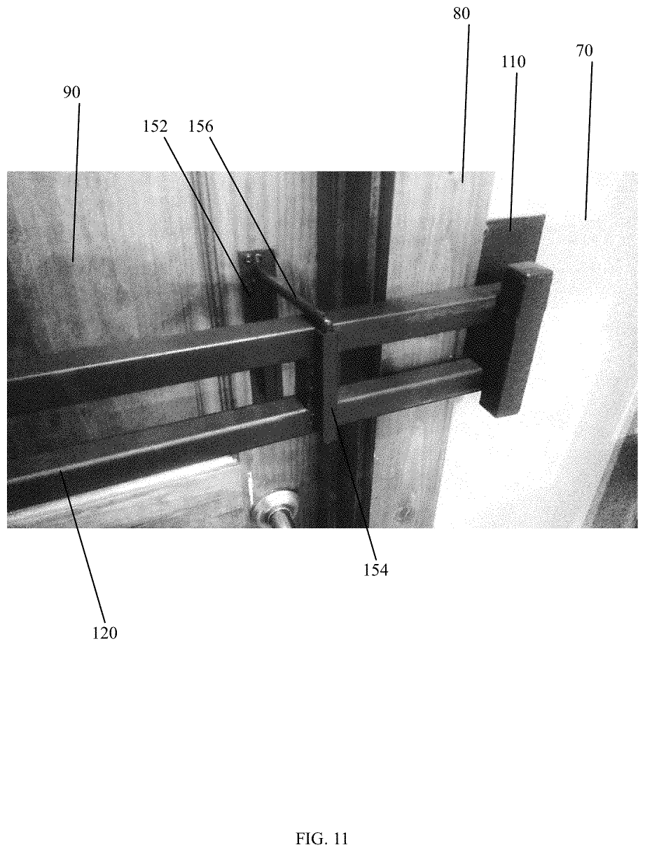

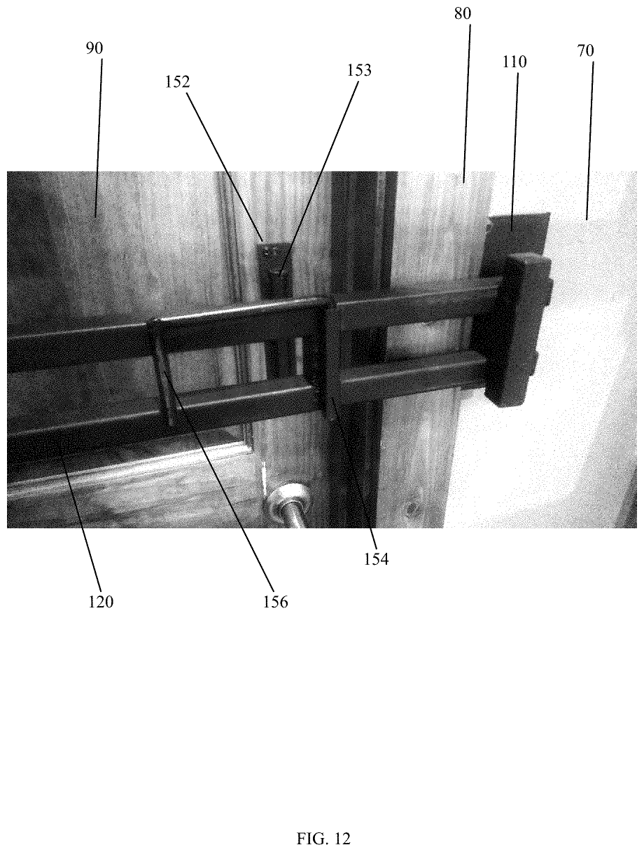

FIGS. 10-12 depict a structure fixture 110 attached to a wall 70 outside a doorway formed by frame 80, and a rigid bar portal cover engagement subsystem 150. The arrangement of the spanning element 120, structure fixture 110, door 90, frame 80, and wall 70 remain as described above. The rigid bar portal cover engagement subsystem 150 includes a door portion 152, a spanning element portion 154, and a rigid bar 156. The door portion 152 includes a plate for mounting to the door, and a receiver for accepting on arm of a “C” shaped rigid bar 156. The spanning element portion 154 of the rigid bar portal cover engagement subsystem 150 includes a receiver 154 for accepting the other arm of the “C” shaped rigid bar 156. When the “C” shaped rigid bar is engaged with the receiver of the door portion 152 and the spanning element portion 154, regardless of the play between the door 90 and the spanning member 120, the door 90 will be prevented from moving. In some embodiments, the rigid bar 156 is adjustable (for example by including a threaded sleeve connecting the portions of the rigid bar that fit into each receiver) to accommodate different distances created by different combinations of spanning elements, fixtures, frames, and doors.

In some embodiments, a Universal System consists of the base kit plus ⅜-inch solid metal hooks and metal receiving points ⅛″×5″×1 ¼″ attached to the door. When the system is engaged the hooks located on the dual bars lift and slide into the receiving point on the door. This hook system is easily and quickly engaged. This unit also physically attaches the door to the bars and locks into a single unit. With this system you can also remove the hinge pins as well as the doorknob and still not gain access. This system can be used on inswing, outswing, as well as left-handed and right-handed doors.

The technology disclosed herein addresses doors using these systems are held solid to the entire frame allowing no movement eliminating weak points for accessibility. Because of the positive lock system through the threaded or hooked version the hinge pins as well as the doorknob can be completely removed, and the door will stay secured. Also, the systems are completely universal meaning it can be used on most makes and models of doors. This would include inswing, outswing, as well as left-handed and right-handed doors.

In some embodiments, fixture 110 can be attached to door frame 80. In some embodiments, more than one portal cover engagement subsystem can be used, including either multiples or combinations of compression type portal cover engagement subsystem 130, threaded type portal cover engagement subsystem 140, rigid type portal cover engagement subsystem 150, a chain type portal cover engagement subsystem (a chain used in place of rigid element 152).

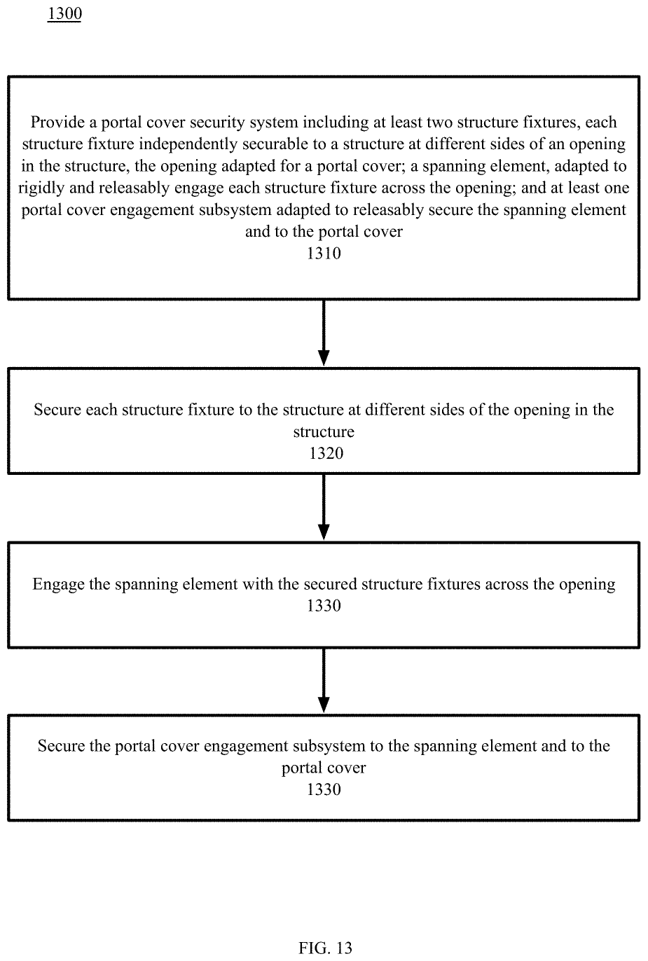

Referring to FIG. 13, and continuing to refer to prior figures for context, methods 1300 to secure portal covers are illustrated, in accordance with examples of the technology disclosed herein. In such methods 1300, a user provides a portal cover security system—Block 1310. The system includes at least two structure fixtures, each structure fixture independently securable to a structure at different sides of an opening in the structure, the opening adapted for a portal cover. The system includes a spanning element, adapted to rigidly and releasably engage each structure fixture across the opening, and at least one portal cover engagement subsystem adapted to releasably secure the spanning element and to the portal cover, impeding opening of the portal cover when the spanning element is engaged with the structure fixtures across the opening.

Each structure fixture is secured to the structure at different sides of the opening in the structure—Block 1320. The spanning element is engaged with the secured structure fixtures across the opening—Block 1330. Th portal cover engagement subsystem is secutred to the spanning element and to the portal cover—Block 1340.

The example systems, methods, and acts described in the embodiments presented previously are illustrative, and, in alternative embodiments, certain acts can be performed in a different order, in parallel with one another, omitted entirely, and/or combined between different example embodiments, and/or certain additional acts can be performed, without departing from the scope and spirit of various embodiments. Accordingly, such alternative embodiments are included in the scope of the following claims, which are to be accorded the broadest interpretation so as to encompass such alternate embodiments.

Although specific embodiments have been described above in detail, the description is merely for purposes of illustration. It should be appreciated, therefore, that many aspects described above are not intended as required or essential elements unless explicitly stated otherwise.

Modifications of, and equivalent components or acts corresponding to, the disclosed aspects of the example embodiments, in addition to those described above, can be made by a person of ordinary skill in the art, having the benefit of the present disclosure, without departing from the spirit and scope of embodiments defined in the following claims, the scope of which is to be accorded the broadest interpretation so as to encompass such modifications and equivalent structures.

We claim:

1. A system to secure portal covers, comprising:
at least two structure fixtures, each structure fixture independently securable to a structure at different sides of an opening in the structure, the opening adapted for a portal cover;
a spanning element, adapted to rigidly and releasably engage each structure fixture across the opening; and
at least one portal cover engagement subsystem adapted to releasably secure the spanning element and to the portal cover, impeding opening of the portal cover when the spanning element is engaged with the structure fixtures across the opening.

2. The system of claim 1, wherein the portal cover is one of an inward opening door, an outward opening door, a casement window, a sash window, an awning window, a double door, barn type door, shutters, or a portion of a dutch door.

3. The system of claim 1, wherein the portal cover engagement subsystem comprises:
a first portion securable to the portal cover in proximity to the position of the spanning element when the spanning element is engaged with the structure fixtures across the opening; and
a second portion releasably securable between the first portion and the spanning element.

4. The system of claim 3, wherein the second portion comprises at least one of a chain, a rigid member, or a rigid member adjustable in the dimension between the spanning element and the first portion.

5. The system of claim 1, wherein:
each structure fixture comprises:
a plate adapted to be affixed to the structure adjacent the opening;
a “T”-shaped standoff affixed to a side of the plate away from the structure, the standoff creating a space between the plate and the underside of the top portion of the “T,” the space characterized by a first dimension; and
the spanning element comprises:
a pair of rectangular rigid tubes, each characterized by a long dimension sufficient to span the opening and engage each structure fixture in the space, and by a depth less than the first dimension;
a first spacer affixed between the tubes at a distance proximate to the first long dimension end of each tube; and
a second spacer affixed between the tubes at a distance proximate to the second long dimension end of each tube.

6. The system of claim 5, wherein the portal cover engagement subsystem comprises a compression member adapted to exert a force from the spanning element on the portal cover.

7. The system of claim 6, wherein the compression member comprises a threaded shaft captive to one of the first spacer or second spacer in a direction substantially normal to the portal cover, the shaft having a turning nob at the end distal to the portal cover, and a compression surface at the end of the shaft proximal to the portal cover.

8. A method to secure portal covers, comprising:
providing a portal cover security system comprising:
at least two structure fixtures, each structure fixture independently securable to a structure at different sides of an opening in the structure, the opening adapted for a portal cover;
a spanning element, adapted to rigidly and releasably engage each structure fixture across the opening;
at least one portal cover engagement subsystem adapted to releasably secure the spanning element and to the portal cover, impeding opening of the portal cover when the spanning element is engaged with the structure fixtures across the opening;
securing each structure fixture to the structure at different sides of the opening in the structure;
engaging the spanning element with the secured structure fixtures across the opening;
securing the portal cover engagement subsystem to the spanning element and to the portal cover.
